(19) United States
(12) Patent Application Publication
(10) Pub. No.: US 2009/0301414 A1
(43) Pub. Date: Dec. 10, 2009

(54) OIL HEAT EXCHANGE APPARATUS IN A CYLINDER HEAD

(75) Inventor: Hironao Netsu, Yokohama-shi (JP)

Correspondence Address: DRINKER BIDDLE & REATH (DC), 1500 K STREET, N.W., SUITE 1100, WASHINGTON, DC, 20005-1209, US

(73) Assignee: NISSAN MOTOR CO., LTD., Yokohama-shi (JP)

(21) Appl. No.: 12/480,007

(22) Filed: Jun. 8, 2009

(30) Foreign Application Priority Data
Jun. 9, 2008 (JP) 2008-150011

(51) Int. Cl. F02F 1/10; F28D 15/00

(52) U.S. Cl. 123/41.72; 165/104.11

(57) ABSTRACT

An oil heat exchange apparatus is provided for an internal combustion engine having cylinders aligned in a cylinder row direction. The oil heat exchange apparatus includes a cylinder head having a cylinder head coolant path through which a coolant flows, a cylinder block having a cylinder block coolant path through which the coolant flows parallel to the coolant flow through the cylinder head coolant path, and an oil passage through which oil flows. The oil passage is configured and arranged to exchange heat with the coolant flowing through both the cylinder block coolant path and the cylinder head coolant path.

### CROSS-REFERENCE TO RELATED APPLICATIONS

This application claims priority to Japanese Patent Application No. 2008-150011 filed Jun. 9, 2008, which is incorporated by reference herein in its entirety.

### BACKGROUND OF THE INVENTION

1. Field of the Invention

The present invention relates to an oil heat exchange apparatus in an internal combustion cylinder head, the oil heat exchange apparatus including an oil passage and a dual-circuit cooling system. The dual-circuit cooling system for an internal combustion engine has two separate cooling circuits for the cylinder head and a cylinder block and in which coolant flows separately through a cylinder head coolant jacket and a cylinder block coolant jacket.

2. Description of the Related Art

Various dual-circuit cooling systems have been proposed, and are now in practical use. In a dual-circuit cooling system, coolant flows separately through a cylinder head coolant jacket and a cylinder block coolant jacket because the cylinder head and cylinder block have different cooling demands and operational requirements. For example, walls of a cylinder head, proximal to where combustion occurs, become comparatively hotter during operation of the engine and thus are provided with more cooling, while the temperature of a cylinder block is kept relatively high, particularly during engine startup, so as to prevent problems with friction (i.e., insufficient lubrication) due to oil viscosity.

Oil discharged from an oil pump of the internal combustion engine is supplied from an oil gallery in the cylinder block to the cylinder head, and is then used in sections of the cylinder head. In prior dual-circuit cooling systems, oil discharged from the oil pump exchanges heat with cylinder block coolant via a heat exchanger in order to quickly raise the temperature of oil after the start of the engine and to cool the oil after the temperature of oil is raised once the engine has reached a normal operating temperature.

### SUMMARY OF THE INVENTION

According to an aspect of the present invention, there is provided an oil heat exchange apparatus including an oil passage for an internal combustion engine. The internal combustion engine includes a dual-circuit cooling system in which coolant flows separately through a cylinder head coolant jacket and a cylinder block coolant jacket. Oil discharged from an oil pump flows through the oil passage and exchanges heat with both cylinder block coolant and cylinder head coolant.

In one embodiment, an oil heat exchange apparatus is provided for an internal combustion engine having cylinders aligned in a cylinder row direction. The oil heat exchange apparatus includes a cylinder head having a cylinder head coolant path through which a coolant flows, a cylinder block having a cylinder block coolant path through which the coolant flows parallel to the coolant flow through the cylinder head coolant path, and an oil passage through which oil flows. The oil passage is configured and arranged to exchange heat with the coolant flowing through both the cylinder block coolant path and the cylinder head coolant path.

In another embodiment, an oil heat exchange apparatus is provided for an internal combustion engine having cylinders aligned in a cylinder row direction and a dual-circuit cooling system. The oil heat exchange apparatus includes a cylinder head having a cylinder head coolant jacket through which coolant flows in the cylinder row direction, the cylinder head coolant jacket including a cylinder head cooling-water outlet at a downstream end of the cylinder head coolant jacket which opens to a first surface of the cylinder head. The oil heat exchange apparatus further includes a cylinder block having a cylinder block coolant jacket through which coolant flows parallel to the coolant flow of the cylinder head coolant jacket, and a partition wall separating the cylinder head coolant jacket and the cylinder block coolant jacket. The cylinder head includes a communication opening at a cylinder block facing surface in communication with the cylinder block coolant jacket, and an exit chamber formed in the cylinder head in communication with the cylinder block coolant jacket via the communication opening and opening to the first surface of the cylinder head adjacent to the cylinder head cooling-water outlet. An oil passage is formed in the partition wall, the oil passage being configured and arranged to exchange heat with the coolant in both of the cylinder block coolant jacket and the cylinder head coolant jacket.

In another embodiment, an oil heat exchange apparatus is provided for an internal combustion engine having a cylinder head and a cylinder block. The oil heat exchange apparatus includes cylinder head cooling means, cylinder block cooling means, and heat exchange means for exchanging heat between engine lubricating oil and both the cylinder block cooling means and the cylinder head cooling means, the heat exchange means being disposed between the cylinder block cooling means and the cylinder head cooling means.

In a warm-up stage of the engine in which the temperature of the engine oil is lower than the temperature of the coolant, the oil is heated by cylinder block coolant, which has a temperature higher than that of cylinder head coolant, thus allowing the temperature of the oil to be raised quickly. After the warm-up is completed and the temperature of the oil becomes higher than the temperature of the coolant, effective cooling can be performed by the cylinder head coolant, which has a temperature lower than that of the cylinder block coolant.

### BRIEF DESCRIPTION OF THE DRAWINGS

The accompanying drawings, which are incorporated herein and constitute part of this specification, illustrate preferred embodiments of the invention, and together with the general description given above and the detailed description given below, serve to explain features of the invention.

FIG. 1 is a cross-sectional view of a cylinder head having an oil heat exchange apparatus according to an embodiment of the present invention, taken along line I-I in FIG. 2;

FIG. 2 is a rear view of a rear end of the cylinder head of the embodiment of the present invention;

FIG. 3 is a cross-sectional view of the cylinder head of the embodiment of the present invention, taken along line III-III in FIG. 1;

FIG. 4 is a schematic diagram of a coolant path in an internal combustion engine including the cylinder head having the oil heat exchange apparatus of the embodiment of the present invention; and

FIG. 5 is a flow chart view of a path of oil flow in the cylinder head having the oil exchange apparatus of the embodiment of the present invention.

### DESCRIPTION OF THE PREFERRED EMBODIMENTS

An embodiment of the present invention will be described in detail below with reference to the attached drawings.

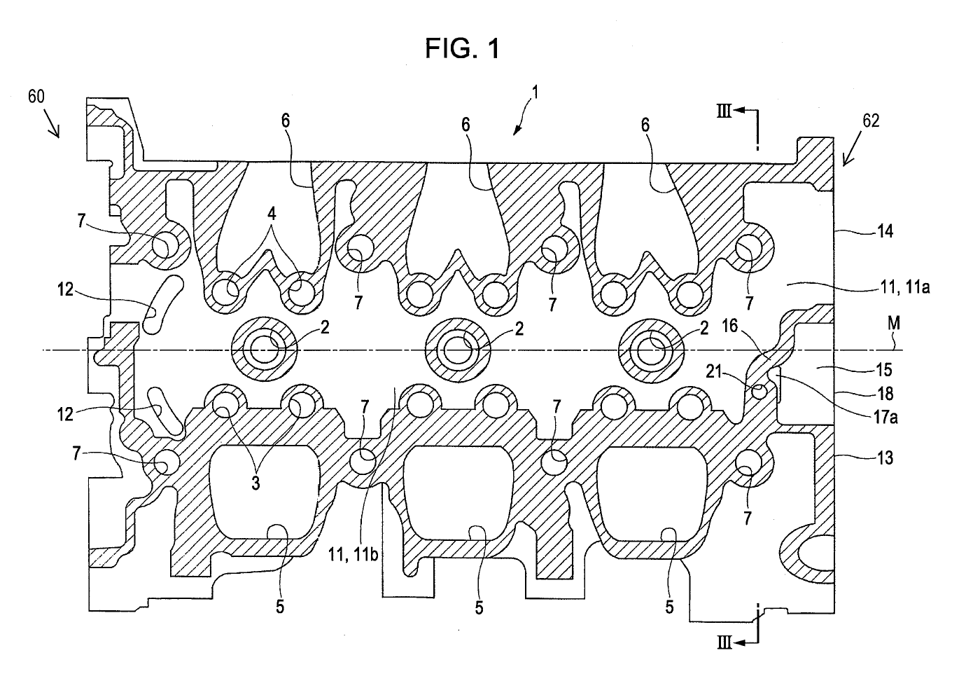

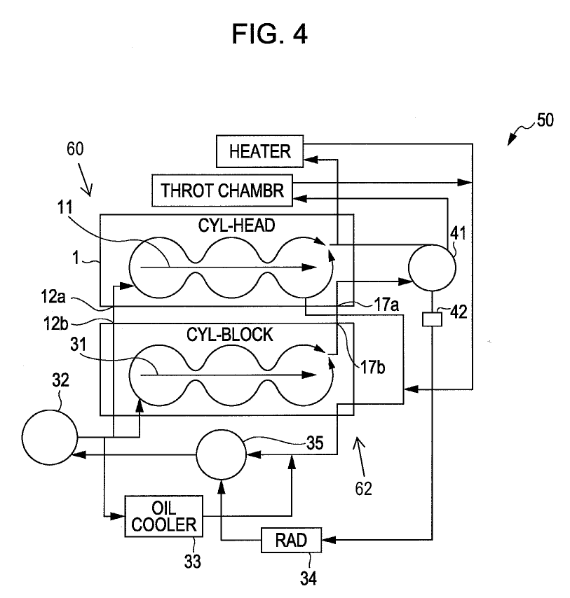

FIGS. 1 to 3 show a cylinder head 1 in an internal combustion engine having an oil heat exchange apparatus including an oil passage structure according to an embodiment of the present invention. The cylinder head 1 is adapted to be bolted onto a cylinder block (not shown). As depicted, the cylinder head 1 is used in a bank of one of an inline three-cylinder internal combustion engine or a V-six cylinder internal combustion engine, and includes three cylinders arranged in a cylinder row direction. However, it is understood that the oil heat exchange apparatus having an oil passage structure described herein is not limited to such a configuration but can be used, for example, in an inline four-cylinder or six-cylinder engine, or in a four-cylinder bank of a V-eight engine. FIG. 4 is a schematic diagram of a dual-circuit cooling system 50 in an internal combustion engine including the cylinder head 1.

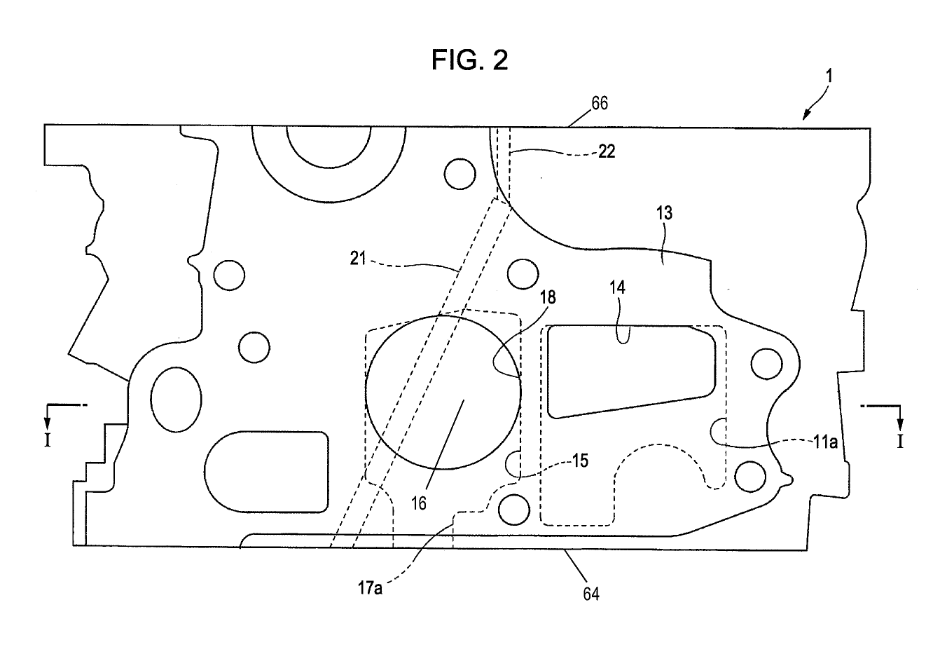

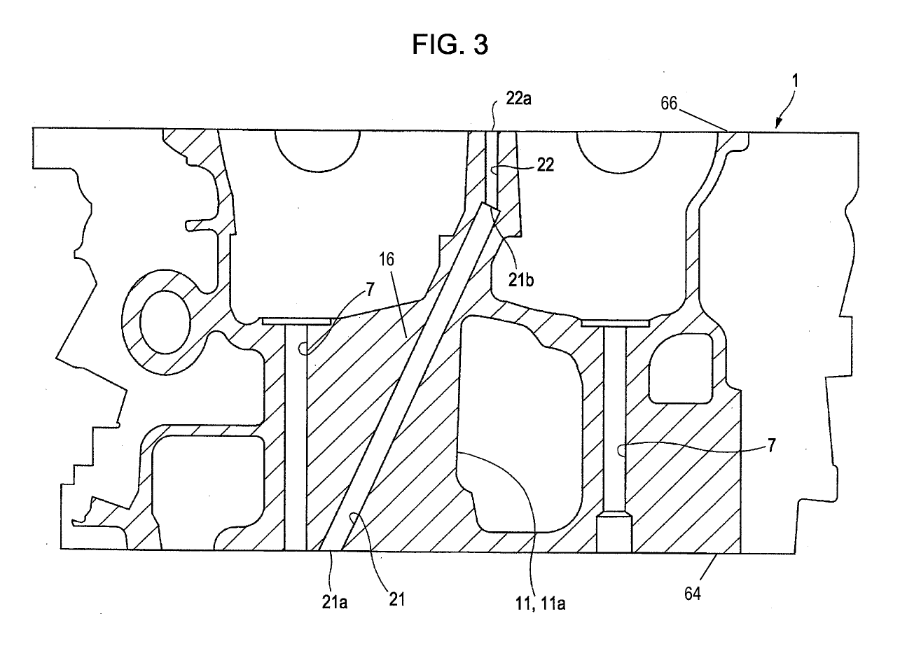

FIG. 2 shows a rear end face 62 of the cylinder head 1 at one end in the cylinder row direction. FIG. 1 corresponds to a cross-sectional view taken along line I-I in FIG. 2, and FIG. 3 corresponds to a cross-sectional view taken along line III-III in FIG. 1. In the depicted embodiment of FIG. 1, the cylinder head 1 includes three cylinders arranged in the cylinder row direction. Each cylinder includes a spark plug insertion hole 2 at its center, a pair of intake valve guide holes 3, and a pair of exhaust valve guide holes 4. In FIG. 1, intake ports 5 and exhaust ports 6 are shown in cross section taken horizontal to the cylinder center direction (direction perpendicular to the plane of FIG. 1). A plurality of head bolt holes 7 in which cylinder head bolts are inserted are arranged to surround each cylinder.

This cylinder head 1 is integrally cast from, for example, an aluminum alloy or iron. In the cylinder head 1, a cylinder head coolant jacket 11 serving as a cylinder head coolant path is formed using a core so that the cylinder head coolant jacket 11 extends continuously in the cylinder row direction. The cylinder head coolant jacket 11 is exposed to walls of the combustion chambers in the cylinders, and surrounds the intake ports 5 and the exhaust ports 6. Further, the cylinder head coolant jacket 11 continuously extends in the cylinder row direction from one end (front end) to the other end (rear end) of the cylinder head 1.

The cylinder head coolant jacket 11 communicates with a cylinder block coolant jacket 31. The cylinder block coolant jacket 31 is provided as a coolant path in the cylinder block via one or a plurality of communication openings 12a that opens at a position closer to the front end 60 than the front cylinder in the cylinder row direction. That is, as shown in FIG. 4, coolant supplied under pressure to the cylinder block coolant jacket 31 by a water pump 32 partly flows into the cylinder head 1 via a communication opening 12b provided at the front end 60 of the cylinder block coolant jacket 31. The communication opening 12a serves as an entrance to the cylinder head coolant jacket 11 for the coolant, and distributes the coolant into the cylinder head coolant jacket 11. Part of the coolant supplied by pressure by the water pump 32 exchanges heat with oil in an oil cooler 33 and then recirculates.

The rear or downstream end 62 of the cylinder head coolant jacket 11 opens as a cylinder head coolant outlet 14 in a rear end face 13 of the cylinder head 1. The coolant outlet 14 is opened and closed by a valve mechanism 41 so as to substantially control the flow of the coolant through the cylinder head coolant jacket 11. For example, opening and closing of the valve mechanism 41 can be controlled by a sensor 42 for detecting the temperature of the coolant. The flow of coolant through the cylinder block coolant jacket 31 is also controlled by the valve mechanism 41 on the downstream side. When the temperature of the internal combustion engine becomes high, a thermostat valve 35 opens, and a radiator 34 radiates heat from the coolant for heat exchange. In this way, the internal combustion engine includes a dual-circuit cooling system including dual coolant paths in which coolant flows in parallel through the cylinder head 1 and the cylinder block and in which the temperatures of the cylinder head 1 and the cylinder block can be controlled independently.

In an alternative arrangement, instead of being supplied to the cylinder head coolant jacket 11 and the cylinder block coolant jacket 31 via the communication openings 12a and 12b communicating with each other, coolant may be supplied from the water pump 32 through independent coolant inlets. Further, instead of being provided on the exit side, the valve mechanism 41 may be provided on the entrance side so that the flows of coolant are controlled on the entrance side, that is, on the upstream side.

As is well known, in a dual-circuit cooling system in which coolant flows separately through the cylinder head coolant jacket 11 and the cylinder block coolant jacket 31, the preset temperature for passing the coolant is higher in the cooling path of the cylinder block (i.e., the cylinder block coolant jacket 31) than in the cooling path of the cylinder head (i.e., the cylinder head coolant jacket 11). Therefore, for example, after cooling starts, a warm-up is performed to quickly raise the temperature of the cylinder wall in a state in which coolant still remains in the cylinder block coolant jacket 31. During operation of the engine after the warm-up, the flow of coolant is controlled so that the walls of the combustion chamber in the cylinder head 1 (which are exposed to the highest combustion temperatures) are actively cooled while the temperature of the cylinder wall is kept higher than that of the combustion chamber walls. However, because the oil is cooled by heat exchange with the coolant in the cylinder block whose temperature is higher than the temperature of the cylinder head, the oil cooling effect is small, and for example, a large heat exchanger is necessary.

The cylinder head coolant jacket 11 includes a main flow section 11b and a downstream section 11a. Referring to FIGS. 1 and 2, the main flow section 11b is a path extending in the cylinder row direction near the spark plug insertion holes 2 of the cylinders. The downstream section 11a laterally and obliquely bends (specifically, toward the exhaust valve) from the cylinder row direction at the rear end 62 of the cylinder head 1. In other words, the cylinder head coolant outlet 14 opens at a position offset from a cylinder head center line M (i.e., a center line passing through the centers of the three cylinders as shown in FIG. 1) extending in the cylinder row direction toward the exhaust valve.

At the rear end 62 of the cylinder head 1, an exit chamber 15 serving as an exit of the cylinder block coolant jacket 31 is formed using a core so that the exit chamber 15 is adjacent to the downstream section 11a of the cylinder head coolant jacket 11. The exit chamber 15 is separated from the cylinder head coolant jacket 11 by a partition wall 16 provided therebetween. As shown in FIG. 2, the exit chamber 15 has a communication opening 17a that opens in a lower surface 64 of the cylinder head 1. The communication opening 17a allows the exit chamber 15 to communicate with a communication opening 17b provided at the rear end 62 of the cylinder block coolant jacket 31 in the cylinder block (see FIG. 4). Further, the exit chamber 15 has a circular cylinder block coolant outlet 18 that opens in the rear end face 13 of the cylinder head 1, as shown in FIG. 2. The cylinder block coolant outlet 18 opens near the center of the cylinder head 1, that is, at a position along the cylinder head center line M, as shown in FIG. 1. Further, the cylinder block coolant outlet 18 is adjacent to the cylinder head coolant outlet 14 in the lateral direction which is perpendicular to the cylinder row direction. That is, coolant flowing in the cylinder row direction through the cylinder block coolant jacket 31 flows into the exit chamber 15 of the cylinder head 1 via the communication openings 17b and 17a at the rear end 62 of the engine, and is finally exhausted from the cylinder block coolant outlet 18.

The downstream section 11a of the cylinder head coolant jacket 11 is offset from the cylinder head center line M toward the exhaust valve (exhaust ports 6), and the exit chamber 15 that forms a part of the cylinder block coolant path is provided near the center of the cylinder head 1 along the cylinder head center line M. Thus, the partition wall 16 for separating the downstream section 11a and the exit chamber 15 obliquely extends from an intake-valve-side inner wall surface of the cylinder head coolant jacket 11 toward the rear end face 13 of the cylinder head 1, as shown in FIG. 1.

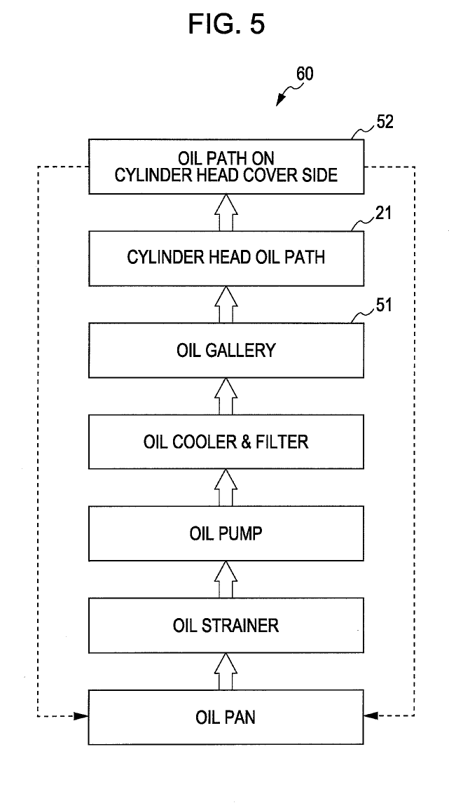

Inside the partition wall 16, a first oil passage 21 extends in the vertical direction. As shown schematically in FIG. 5, in an oil passage 60 of the lubricant oil passage, the first oil passage 21 in the cylinder head 1 receives oil from an oil gallery 51 provided in a lower deck of the cylinder block, and communicates oil to an oil passage 52 provided in a cylinder head cover.

Referring to FIGS. 2 and 3, the first oil passage 21 is inclined with respect to the cylinder axis, as viewed from the rear of the engine. The cylinder axis is defined as the axis about which the cylinders reciprocate in the cylinder block. In this embodiment, the inclined first oil passage 21 is linearly drilled, and a lower end 21a thereof opens at a position adjacent to the head bolt hole 7 on the intake valve side, and is connected to an upper end of an oil passage extending in the vertical direction in the cylinder block. An upper end 21b of the inclined first oil passage 21 is connected to a substantially vertical second oil passage 22, and the second oil passage 22 opens in an upper surface 66 of the cylinder head 1. The second oil passage 22 is connected to the oil passage in the cylinder head cover via an opening 22a so that oil is supplied to the portions of the cylinder head 1 that need the oil.

As shown in FIG. 2, the first oil passage 21 overlaps with the exit chamber 15 of the cylinder block coolant path 31, when projected along the front-rear direction of the engine. Referring to FIG. 1, the first oil passage 21 also overlaps with the cylinder head coolant jacket 11, when projected along the front-rear direction of the engine.

In the above-described configuration, the partition wall 16 in which the first oil passage 21 extends is in contact with both the coolant flowing in the cylinder head coolant jacket 11 (which cools the cylinder head 1) and the coolant flowing in the exit chamber 15 (which cool the cylinder block). Thus, heat exchange is actively performed between the oil flowing in the first oil passage 21 and the coolant from both the cylinder head coolant jacket 11 and the cylinder block coolant jacket 31.

For a time period after the start of the engine and while warm-up of the engine is occurring, the temperature of the oil is lower than the temperature of the coolant; however, the temperature of the oil is promptly raised because the oil receives heat from the cylinder block coolant that is kept at a relatively high temperature in the dual-circuit cooling system. When the warm-up of the engine is completed, the temperature of the oil is higher than that of the coolant. Thus, when the engine is fully warmed up, the oil is effectively cooled by the cylinder head coolant, which is kept at a relatively low temperature in the dual-circuit cooling system as compared with the cylinder block cooking water.

In particular, the main flow of coolant flowing in the cylinder row direction along the center line M of the cylinder head 1 collides with the partition wall 16, where the direction of the main flow is turned toward the downstream section 11a that is offset laterally. The collision or impingement of the coolant against the partition wall 16 causes a high rate of heat transfer at the point of impingement. Therefore, since the first oil passage 21 is present at the colliding position of the main flow of coolant, cooling is performed effectively. Moreover, since the first oil passage 21 extends obliquely (i.e., the first oil passage 21 is inclined with respect to a cylinder axis), the length of contact of the first oil passage 21 with the highest heat transfer portion of the partition wall 16 can be made larger than if such an oil passage were to extend only along (i.e., parallel to) the cylinder axis. As a result, the heat exchange area is increased and heat exchange is more efficient. Also, because the lower end 21a of the first oil passage 21 is offset toward the intake valve side of the cylinder head 1, it does not receive excessive exhaust heat, and the temperature of the lower end 21 of the first oil passage 21 is lower than if it were to be located on the exhaust valve side of the cylinder head 1, where the temperature is higher. Thus, the oblique orientation of the first oil passage 21 further provides an advantage in cooling the oil. Accordingly, for example, it is possible to limit the maximum temperature of the oil during high-load operation, and to use an external oil cooler having a relatively lower heat exchange performance, or to eliminate the need for an external oil cooler.

While the invention has been disclosed with reference to certain preferred embodiments, numerous modifications, alterations, and changes to the described embodiments are possible without departing from the sphere and scope of the invention, as defined in the appended claims and equivalents thereof. Accordingly, it is intended that the invention not be limited to the described embodiments, but that it have the full scope defined by the language of the following claims.

What is claimed is:

1. An oil heat exchange apparatus for an internal combustion engine having cylinders aligned in a cylinder row direction, the oil heat exchange apparatus comprising:
a cylinder head having a cylinder head coolant path through which a coolant flows;
a cylinder block having a cylinder block coolant path through which the coolant flows parallel to the coolant flow through the cylinder head coolant path; and
an oil passage through which oil flows;
wherein the oil passage is configured and arranged to exchange heat with the coolant flowing through both the cylinder block coolant path and the cylinder head coolant path.

2. The oil heat exchange apparatus according to claim 1, further comprising:
an oil gallery formed in the cylinder block;
wherein the oil passage is formed in the cylinder head; and
wherein the oil passage is configured and arranged to fluidly communicate with the oil gallery to supply oil to the oil passage.

3. The oil heat exchange apparatus according to claim 1,
wherein the cylinder head includes a first end and a second end opposite the first end in the cylinder row direction; and
wherein the cylinder block coolant path includes a cylinder block coolant path exit formed in the second end of the cylinder head.

4. The oil heat exchange apparatus according to claim 3, further comprising:
a partition wall separating the cylinder block coolant path exit from the cylinder head coolant path;
wherein the oil passage is formed in the partition wall.

5. The oil heat exchange apparatus according to claim 4, wherein:
the cylinder head coolant path extends from the first end of the cylinder head to the second end of the cylinder head in the cylinder row direction, and includes a cylinder head coolant path exit formed in the second end of the cylinder head.

6. The oil heat exchange apparatus according to claim 5,
wherein the cylinder head coolant path exit opens onto an end surface of the second end of the cylinder head at a position laterally offset from a central axis of the cylinder head, which extends parallel to the cylinder row direction; and
wherein the oil passage is formed in the partition wall at a lateral position corresponding to the lateral position of the cylinder block coolant path exit and adjacent to the cylinder head coolant path exit.

7. The oil heat exchange apparatus according to claim 6,
wherein the cylinder head includes an intake side of the central axis and an exhaust side of the central axis, the exhaust side being located opposite the intake side with respect to the central axis; and
wherein the cylinder head coolant path exit is offset toward the exhaust side of the cylinder head.

8. The oil heat exchange apparatus according to claim 4,
wherein the cylinder head coolant path includes a main flow section through which the coolant flows in the cylinder row direction and a cylinder head coolant path exit which opens at a position offset from the main flow section; and
wherein the partition wall is configured and arranged to direct a flow of the coolant in the main flow section toward the cylinder head coolant path exit.

9. The oil heat exchange apparatus according to claim 2, wherein:
the oil passage extends linearly and is inclined with respect to a cylinder axis to increase the length of the oil passage disposed within the partition wall.

10. The oil heat exchange apparatus according to claim 2, wherein:
the cylinder head includes an intake side with respect to a central axis of the cylinder head which extends parallel to the cylinder row direction; and
wherein the oil passage includes an opening at a cylinder block facing surface of the cylinder head and is offset toward the intake side of the cylinder head.

11. The oil heat exchange apparatus according to claim 1, further comprising:
a cylinder block coolant path exit formed in an end of the cylinder head; and
a partition wall in the cylinder head separating the cylinder block coolant path exit from the cylinder head coolant path, the partition wall being arranged and configured so that coolant flowing through the cylinder head coolant path impinges against the partition wall;
wherein the oil passage is formed in the partition wall.

12. The oil heat exchange apparatus according to claim 11, wherein:
the oil passage extends linearly and is inclined with respect to a cylinder axis to increase the length of the oil passage disposed within the partition wall that is impinged against by the coolant flowing through the cylinder head coolant path.

13. The oil heat exchange apparatus according to claim 11,
wherein the cylinder head has a central axis, the cylinder head having an intake side and an exhaust side located opposite each other with respect to the central axis; and
wherein the oil passage is offset toward the intake side of the cylinder head.

14. An oil heat exchange apparatus for an internal combustion engine having cylinders aligned in a cylinder row direction and a dual-circuit cooling system, the oil heat exchange apparatus comprising:
a cylinder head having a cylinder head coolant jacket through which coolant flows in the cylinder row direction, the cylinder head coolant jacket including a cylinder head coolant outlet at a downstream end of the cylinder head coolant jacket which opens to a first surface of the cylinder head;
a cylinder block having a cylinder block coolant jacket through which coolant flows parallel to the coolant flow of the cylinder head coolant jacket; and
a partition wall separating the cylinder head coolant jacket and the cylinder block coolant jacket;
wherein the cylinder head includes a communication opening at a cylinder block facing surface in communication with the cylinder block coolant jacket, and an exit chamber formed in the cylinder head in communication with the cylinder block coolant jacket via the communication opening and opening to the first surface of the cylinder head adjacent to the cylinder head cooling-water outlet; and
wherein an oil passage is formed in the partition wall, the oil passage being configured and arranged to exchange heat with the coolant in both of the cylinder block coolant jacket and the cylinder head coolant jacket.

15. An oil heat exchange apparatus for an internal combustion engine having a cylinder head and a cylinder block, the oil heat exchange apparatus comprising:
cylinder head cooling means;
cylinder block cooling means; and
heat exchange means for exchanging heat between engine lubricating oil and both the cylinder block cooling means and the cylinder head cooling means, the heat exchange means being disposed between the cylinder block cooling means and the cylinder head cooling means.
